(19) United States
(12) Patent Application Publication
(10) Pub. No.: US 2006/0117253 A1
(43) Pub. Date: Jun. 1, 2006

(54) Methods for altering the display of table data suitably for visualization within visible display widths

(76) Inventor: Peter Polash, Woodside, CA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/001,546

(22) Filed: Dec. 1, 2004

(51) Int. Cl. G06F 17/24

(52) U.S. Cl. 715/517

(57) ABSTRACT

Computer-implemented systems and methods are provided for reformatting tabular data based on the known characteristics of a target display device that would otherwise be insufficient in terms of display resolution to retain the visual cues indicating relationships between data items, in a manner that introduces visual and positional consistency for display of such data.

### BACKGROUND OF THE INVENTION

1. Field of the Invention

The present invention is directed to formatting tabular data for display devices or output media.

2. Background Information

A significant percentage of the pages available for viewing from the Internet and other sources have data arranged in tables. The term table is used here to describe discrete yet related elements of information that are arranged for viewing in rows and columns. An element of data displayed in any specific row and column is called a cell. Among the primary purposes of a typical table arrangement are the following: (1) allow the user to easily identify visual relationships among multiple related data elements and (2) allow the user to infer significance from the relative positions of the data elements.

FIG. 1 shows a typical table data web page as displayed on a full-screen device.

Often, a table will contain more data in each row than can be reasonably displayed in the width of the screen provided by a viewing device. This problem is particularly acute in small-screen devices such as data-capable cell phones and internet-capable personal digital assistants. There are several current ways to address this problem.

U.S. Pat. No. 6,313,848 to Hoag describes one approach to dealing with this issue. The Hoag approach divides a table into multiple distinct sub-tables, each of which contains a distinct subset of columns but a full set of rows. These separate sub-tables are displayed in a vertical stack one above the other. The data associated with any one record are therefore displayed in discontiguous areas of the display, one portion in each of the sub-tables. If the sub-tables together contain more data than the client display can show at the same time, the Hoag approach requires that a program running on the client device divide the display into multiple dedicated, equal-sized, scrollable regions called panes, each of which is associated with a respective one of the sub-tables. To accomplish the goal of displaying all of any record's contents at one time in this scenario, the client program has to provide automatic simultaneous scrolling in all the panes: when the user scrolls one pane to see a portion of a given record, the other panes have to scroll, too, so that the given record's other portions are also visible.

Since the Hoag approach displays data associated with any one record across distinct discontiguous display areas, the data are hard to correlate visually. Moreover, the Hoag approach requires client software that (a) simultaneously displays multiple panes, and (b) simultaneously synchronizes scrolling of all of these panes, whereas existing browsers for small-screen devices support neither feature. So the Hoag approach is not suitable for implementation solely by a proxy-server program or server-based program, which would encode data for display by existing small-screen devices using existing software browsers. Proxy-server or server-based solutions are particularly valuable in that they may serve many clients without requiring any action on the part of an end user.

Another way to address the problem employs a form of display compression that completely eliminates the table structure and all columnar positional consistency by eliminating horizontal white space. This approach is commonly referred to as table-structure elimination or white-space elision. FIG. 6 illustrates a typical table data web page as displayed on a narrow-screen device with table-structure elimination or white-space elision. The data of each cell in a row are displayed as closely as possible to the preceding cell's data. When there is no additional space on the screen for the row's remaining cells, those cells' data are displayed on subsequent display lines. Each successive row displays as much data as can be compressed on the screen. As a result, not all the cells in a source column will necessarily appear in the same horizontal location on the display, because the sizes of those cells' data may vary between rows. This makes it hard for the user to determine visually which data elements belong to which columns.

Another way to address this problem, commonly employed by browser and other display software, is to display such tables on a virtual window that is wider than the screen. This means is commonly referred to as horizontal scrolling. FIGS. 7A and 7B illustrate a typical table web page as displayed on a narrow-screen device with horizontal scrolling to the left (FIG. 7A) and to the right (FIG. 7B). The user would have to scroll horizontally in order to view all elements. Since the user is unable to see all of a row's elements at the same time, he can not as readily glean relational and positional information as he otherwise could.

Another technique is to place all of a source row's cells into a single vertical column. All cells of the first row are displayed in a vertically stacked arrangement followed by similar displays of the cells of all of the successive rows. This greatly diminishes the ability to correlate data visually. The Blazer 2.0 browser program currently used by the PalmOne Treo 300 employs this technique.

Numerous PDA-based browsers take yet another approach, which is to reduce the column widths enough to display all cells of each row entirely within the width of the device and thereby eliminate the need for horizontal scrolling. This approach often regularly produce columns no more that one to three characters wide even though the columns' cells may contain large quantities of text. Such formatting will often display such contents in highly elongated cells with single words distributed across many lines within those cells, whose heights can exceed even that of the screen. The Xiino browser program available for Palm based PDAs, the NetFront 3.1 browser program currently used by the Sony Clie TH55 and other Sony Clies, and the Opera Browser on the Sharp Zaurus PDA platform all use this approach. Despite the limitations of this method, it used for the purpose of avoiding the greater inconvenience of horizontal scrolling. This method's ubiquity despite how hard the resultant displays are to read illustrates the degree to which a better solution is needed.

### SUMMARY OF THE INVENTION

Although reduced screen resolution necessarily results in some loss of readability, we have recognized that some of the readability loss results from shortcomings in conventional dynamic display-formatting techniques, and we have devised a way of reducing that loss.

Our approach to determining a display layout dynamically retains to a great degree the visual data-correspondence cues that high-resolution-display layouts tend to afford. To understand our approach, first consider the nature of those visual cues. In most (but not all) applications of the invention, the apparatus that implements it receives inputs, such as HTML table elements, that explicitly specify rows and columns in which respective source data are to be displayed. Usually a top row identifies attributes, such as name, age, and social-security number, whose values are to be displayed in the respective columns. Correspondence among certain data—i.e., the fact that they are all respective values of the same attribute, such as age—is apparent in the input from the fact that those data occupy the same column, whereas different-attribute values can be recognized as belonging to the same record if they occupy the same row. Now, the inputs in some embodiments will not thus explicitly specify a table layout. But the correspondences will nonetheless be apparent, either because the data sets they represent give the correspondences explicitly, such as by tagging different value fields with common attribute names, or because they do so implicitly, such as by giving corresponding data fields common ordinal positions within their respective records.

If the display's resolution is high enough, of course, it can readily provide visual cues to those data correspondences: all of a record's data can be placed in the same row, and all corresponding data can be placed in the same column. When resolution is not high enough, on the other hand, placing all of a record's data in a common row is not practical. But the display's resolution may still be great enough to permit use of a technique that, in accordance with the present invention's teachings, we employ in such situations.

Specifically, we adapt to dynamic layout determination an approach previously employed only in some manually predetermined, static display layouts: we lay each record's display contents out “two-dimensionally.” Many embodiments will provide this two-dimensionality by displaying in vertically displaced subrows data that otherwise would occupy the same row. But that is not the only way to provide two-dimensional layouts; for present purposes, any layout of the display contents derived from a given record'data fields will be considered two-dimensional so long as (1) at least two display cells whose contents are derived from fields of that record are located one entirely above the other and (2) at least two display cells whose contents are derived from fields of that record are located one entirely to the left of the other.

The determination of whether to rearrange the data and how to do so is dynamic: there exists at least one pair of data sets such that some combination of the first of the data sets and an associated resolution results in a layout different from the one that results from the second of the data sets and a respective resolution even though the data sets are exactly the same in the number of records, number of fields in each record, and the order of the attributes of which those fields contain values. (By “different” here we mean that at least two adjacent cells in the first layout correspond to non-adjacent cells in the second layout, where cells are considered to correspond when they are derived from the same source column. The different layouts may result from different data values, different resolutions, or both.)

Now, rearranging a record's data two-dimensionally may to an extent result in some loss of visual data-correspondence cues. But our technique retains the property, common in one-row-per-record layouts, that all display cells whose contents are derived from corresponding source data fields have a consistent absolute horizontal position. Moreover, it so lays out display contents derived from a given record's fields that they are what we will define below as “contiguous” and located in such a relationship to other records' display contents that all cells whose contents are derived from corresponding source data fields have what we describe below as a “consistent relative vertical position.”

When we say that display contents from the same record are “contiguous,” we mean that in a broad sense. Specifically, we mean that the resultant layout of the data set to which the record belongs can be divided into regions vertically by non-intersecting boundaries that extend between the layout's left and right sides in such a manner that all display contents derived from the same record's data fields are displayed in the same region, to the exclusion of all other records' display contents.

By thus ensuring that the display contents from the same record remain contiguous, we afford a visual cue to indicate record membership even though a record's display contents do not occupy a common row. Now, we believe that the cue is most effective if the display contents are so laid out that straight horizontal boundaries can be drawn between successive records' regions. To an extent, though, the present invention's advantages remain even if the embodiment produces layouts in which no straight horizontal boundary can be drawn between different records' regions. For example, consider a layout in which a first region's display contents form a salient so that a straight line drawn between two of a second region's display contents can intersect that salient's contents. We would still consider the second region's display contents to be contiguous—even though the boundary between the first and second regions would have to include upward- and downward-extending portions—so long as the boundary can be traversed from the left side of the layout to its right side without ever moving leftward.

Cues to data correspondence result not only do from horizontal position but also from vertical position. Now, the invention may sometimes be so implemented that the heights of corresponding cells in different records differ, typically as a result of different display contents. But we so lay display contents out that corresponding cells have consistent relative vertical positions: a first cell in one region will be located above a second cell in that region whenever in some other region a cell corresponding to the first cell is located above a cell that corresponds to the second cell.

Determining display layouts in accordance with the above-described relationship between layout and the resolution and data set can lessen the loss in readability that resolution reduction causes.

### BRIEF DESCRIPTION OF THE DRAWINGS

The invention description below refers to the accompanying drawings, of which:

FIG. 1 shows an exemplary illustration of a source table;

FIG. 2 schematically illustrates an exemplary system for formatting the table of FIG. 1 for display within a visible display width;

FIG. 3 is a flow chart showing an exemplary embodiment of the operation of a table formatting application program as described herein;

FIG. 4A shows an exemplary illustration of a reformatted table layout formatted using the table formatting method application program illustrated by FIG. 3;

FIG. 4B shows an exemplary illustration of a reformatted table layout formatted using the table formatting application program illustrated by FIG. 3, displayed on a display device;

FIGS. 5A and 5B show additional exemplary illustrations of reformatted table layouts formatted using the table formatting application program illustrated by FIG. 3;

FIG. 6 shows a table formatted using one currently used method for formatting the table of FIG. 1 for display within a visible display width; and

FIGS. 7A and 7B show tables formatted using another currently used method for formatting the table of FIG. 1 for display within a visible display width.

### DETAILED DESCRIPTION OF AN ILLUSTRATIVE EMBODIMENT

Before we describe illustrative embodiments of the invention, we will introduce nomenclature that will be helpful in that description.

As used herein, the term source table refers to a collection of data that is stored as a relation that can be presented as a table. Each record in the relation is conventionally displayed as a row of the table. In the rows, contents of fields representing the same attribute are conventionally displayed as a column of the table. Source table also includes any set of computer instructions that specify display data in such rows and columns. The term source row refers to a record in the relation.

As used herein, the terms reformatted table layout and reformatted table refer to the results of formatting or reformatting a source table that has been formatted or reformatted in accordance with the methods described below. The terms reformatted table layout and reformatted table may also include a set of computer instructions that specify data to be displayed as a reformatted table on a display device. Such a reformatted table may take a form that differs from a markup-language table structure, and it may, for example, be such that cells of contiguous rows are not aligned. (As will be seen below, though, all cells will belong to respective display columns, in each of which all cells will still be vertically aligned.)

As used herein, the term source page refers to a set of computer instructions or data that contain one or more source tables and may also include other elements intended for the computer system containing the display device. One example of a source page is the set of computer instructions that is used to generate a web page that displays source tables in grid form, as a set of rows and columns.

As used herein the term reformatted page refers to a page containing one or more reformatted tables.

As used herein the term encoding for display refers to the process of augmenting data by using HTML, CSS, or other markup language such that if a standards-compliant software product receives such augmented data, it can display the data.

The term vertically aligned as used herein when referring to two or more cells means that the distances between the left-hand margin of the display and the left-hand margins of the cells are the same and/or that the distances between the right-hand margin of the display and the right-hand margins of the cells are the same.

The term display column as used herein refers to the set of all reformatted cells in a reformatted table associated with a specific source column, where such reformatted cells are displayed, or encoded for display, in a vertically aligned configuration.

The term interrupted display column as used herein refers to a given display column in which some successive cells are separated vertically by a space occupied by one or more cells of at least one other display column.

The term uninterrupted display column as used herein refers to a display column whose cells are displayed, or encoded for display, in a contiguous configuration.

The methods described herein produce reformatted tables that usually contain at least one interrupted display column, and all of the cells will usually appear in display columns.

In some embodiments, all fields from each source row are configured to be displayed on the display screen in a plurality of display rows (herein referred to as sub-rows) associated with that source row. The phrase sub-row group as used herein refers to the set of all sub-rows associated with a specific source row.

The term reformatted group as used herein refers to all of a reformatted table's cells that are associated with the same source row.

The term markup language as used herein refers to one of the standard languages, such as HTML, XML or SGML, that identifies the logical structure and contents of a document.

When we say that markup-language instructions specify a display layout, we mean that such markup instructions are accompanied by, include, or reference, explicitly or implicitly, in-line or external display layout instructions including but not limited to HTML or other stylistic or presentation instructions, such as Cascading Style Sheets (CSS).

We now turn to a description of illustrative embodiments. Those of ordinary skill in the art will understand that the disclosed devices and methods can be adapted and modified to provide systems and methods for other applications, and that other additions and modifications can be made to the disclosed devices and methods without departing from the scope of invention.

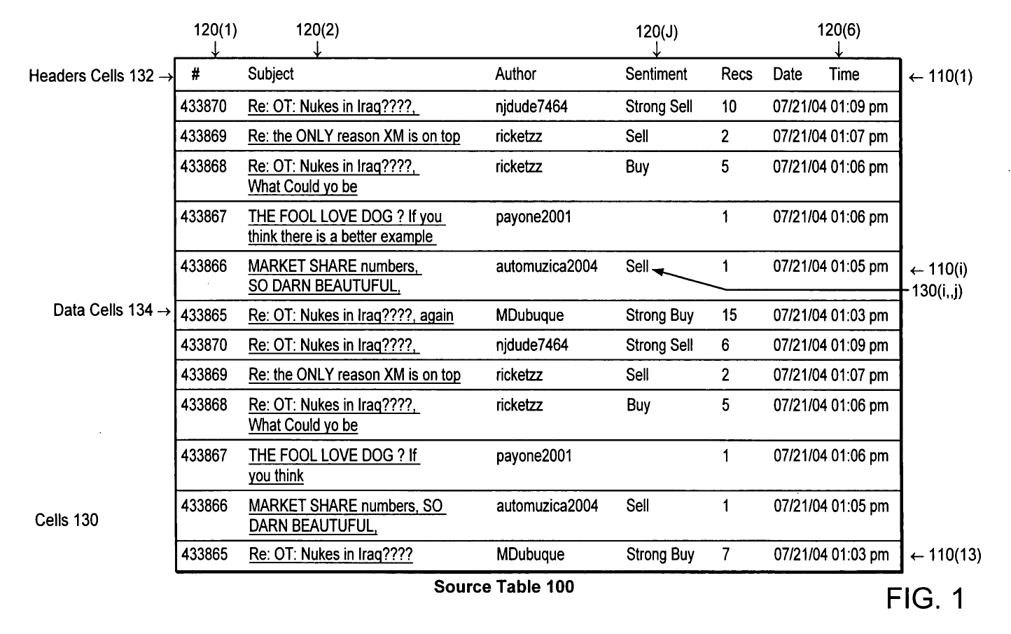

FIG. 1 shows a source table 100 that includes rows 110, columns 120, and cells 130. The rows 110 and columns 120 in source table 100 may be numbered, indexed, or otherwise labeled so as to uniquely identify their locations in source table 100. For example, in source table 100, rows 110 and columns 120 are labeled in the format 110(i) and 120(j), where the indices i and j identify the locations of the ith row and jth column with respect to other rows 110 and columns 120. The cells 130 are included in and/or are otherwise associated with the rows 110 and columns 120. For example, cell 130(i,j) is included in row 110(i) and column 120(j).

The rows 110 and columns 120 define generally perpendicular row- and column-wise directions. For example, in source table 100, the rows 110 and columns 120 define horizontal and vertical directions respectively. The rows 110 and columns 120 define row- and column-wise ascending consecutive orders that begin at the first row 110(1) and column 120(1) and end at the last row 110(13) and column 120(6).

The cells 130 include headers 132 or data 134. As used herein, a header 132 identifies or otherwise describes one or more features of a source table 100, a row 110, and/or a column 120, such as a title or subject matter, a width, and/or one or more other features known to those of ordinary skill in the art. Generally, source table 100 may include zero, one, or more than one header rows, in which some or all of the cell contents included in the row are headers. For example, as shown in FIG. 1, source table 100 includes a header row 110(1).

A video display terminal (VDT) is a processor-controlled device that can visibly display at least text onto a display screen. As used herein, a VDT includes, but is not limited to, a cathode ray tube, a liquid crystal display, a display based on light-emitting diodes, and a display based on a gas plasma. A visible display width of a VDT refers to the maximum horizontal size of the accompanying display screen that is available for visibly displaying or otherwise presenting an image.

For purposes of illustration and not limitation, the disclosed devices and methods are described with respect to formatting source table 100 for display on a typical display screen of a PDA. Source table 100 will be assumed for that purpose to include one or more rows whose widths exceed the visible display width of the PDA. Those of ordinary skill in the art will understand that the disclosed devices and methods are not limited to formatting tables for display on display screens of PDAs and that the disclosed devices and methods can format tables for display within the visible display widths of VDTs used with other devices, as well as with other output media, such as paper.

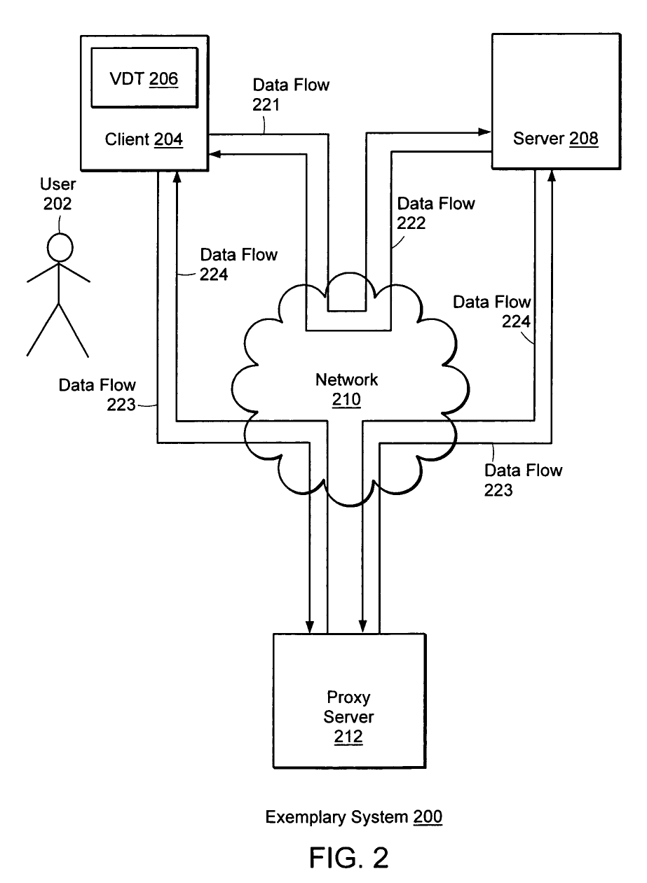

FIG. 2 schematically illustrates an exemplary system for formatting the table of FIG. 1 for display within a visible display width. As shown in FIG. 2, the exemplary system 200 includes a client digital data processing device 204 (“client”) and a server digital data processing device 208 (“server”). The client 204 and server 208 communicate using a data communications network 210 (“network”), for some embodiments as shown by data paths 221 and 222. In other embodiments, the communication between client 204 and server 208 takes place through an intermediary mechanism, proxy server 212, as shown by data paths 223 and 224.

Generally, references herein to a client and a server are used to differentiate two communicating devices and/or sets of processor instructions. References herein to a client and/or a server can thus be understood to be references to communications originating from a client and/or a server as these terms are understood by those of ordinary skill in the art. Such communications can be based on and/or otherwise initiated from one or more input devices (e.g., a keyboard, a stylus, a mouse, etc.) controlled by a user. Also, references herein to a client and/or a server can thus be understood to include one or more processor-controlled devices that act in a client-server (i.e., request-response) model, in which the client and the server can reside on the same processor-controlled device, and in which, based on perspective, the client can act as a server, and the server can act as a client.

The digital data processing devices 204, 208 and 212 can include, but should not be understood as limited to, a PC, a computer workstation (e.g., those manufactured by Sun or Hewlett-Packard), a laptop computer, a notebook computer, a server computer, a mainframe computer, a handheld device (e.g., a PDA, a Pocket PC®, a cellular telephone, a portable email portal (such as a BlackBerry® email portal), a portable intranet or Internet portal, etc.), an information appliance, and/or another type of generic or special-purpose, processor-controlled device capable of receiving, processing, and/or transmitting digital data. A processor refers to the logic circuitry that responds to and processes instructions that drive digital data processing devices and includes, without limitation, a central processing unit, an arithmetic logic unit, an application specific integrated circuit, a task engine, and/or combinations, arrangements, or multiples thereof.

A user 202 can interact with the client 204 by, for example, viewing a command line, using a graphical and/or other user interface, and entering commands via an input device, such as a mouse, a keyboard, a touch sensitive screen, a track ball, a keypad, a stylus, etc. The user interface can be generated by a graphics subsystem of the client 204, which renders the interface into an on- or off-screen surface, such as, for example, on a Video Display Terminal (“VDT”) and/or in a video memory. Inputs from the user 202 can be received via an input/output (I/O) subsystem and routed to a processor via an internal bus (e.g., system bus) for execution under the control of an operating system.

In some embodiments of the exemplary system 200, the client 204 includes a digital data processing device in which a display device 206, such as a VDT, is housed in an integrated unit that includes the processor that controls the VDT. For example, in some of such embodiments, the client 204 includes a PDA or a laptop computer integrated with a display screen. Alternatively, in some embodiments, the client 204 includes a digital data processing device in which the display device 206 is housed in a separate unit that does not include the processor that controls the display device. For example, in some of such embodiments, the client 204 includes a desktop PC operatively coupled to a separate monitor.

Generally, the client 204, and/or the server 208, and/or the proxy server 212, and/or one or more other nodes in the network 210 can include one or more software application programs that are configured for performing the table formatting operations described herein. The one or more software application programs can reside on one or more internal memories and/or one or more external storage media accessible by one or more of the client 204, the server 208, the proxy server 212, and the other node(s) in the network 210.

In some embodiments, the one or more software application programs can be associated with the client 204. In one such embodiment, when client 204 is instructed by the user 202 and/or another process or entity to display one or more source tables on display device 206, client 204 can execute the one or more software application programs to, for example, (i) determine whether the source tables exceeds the visible display width of the display device 206 and, (ii) if so, reformat the source tables and source page for display within the visible display width based on the disclosed methods. Client 204 can then display or encode for display the reformatted page on the display device 206. It will be appreciated that the source tables may be formatted regardless of whether or not the source tables exceeds the visible display width of the display device.

Alternatively, in some embodiments, the one or more software application programs can be associated with the server 208 (and/or another node in network 210). In one such embodiment, when server 208 is instructed by user 202 (e.g., via an Internet browser executing on client 204) and/or another process or entity to provide a source page including one or more tables to client 204 for display on display device 206, server 208 can execute the one or more software application programs to, for example (i) determine whether the table exceeds the visible display width of the display device 206 and, (ii) if so, to reformat the tables within the source page for display within the visible display width based on the disclosed methods. Server 208 can determine whether the tables exceed the visible display width based on querying the client 204 for the visible display width and/or other parameters of the display device 206. Server 208 then provides the reformatted tables with the reformatted page to client 204, and client 204 displays the formatted table on VDT 206.

Alternatively, in other embodiments one or more software application programs for formatting table data for display on a client's VDT 206 can be associated with one or more dedicated intermediary mechanisms, such as proxy server 212. Like the client 204 and/or server 208, the proxy server 212 may be a processor-based device that can include an internal and/or external memory for storing the one or more software application programs described herein for formatting table data as described herein. The proxy server 212 can thus serve several data-requesting clients, such as the client 204, and several data-sending servers, such as server 208. Alternately, the proxy server can serve several data-sending servers, such as server 208, in a mechanism called a “reverse proxy”. It will be appreciated by those skilled in the art, that a reverse proxy server is distinguished from other proxy servers by virtue of the fact that the action of designating use of such server is accomplished on behalf of the data sending servers rather than on behalf of one or more clients. It will be further appreciated that any reference in this document to the term “proxy server” refers to either proxy server or reverse proxy server. Under an arrangement where a proxy server performs necessary data formatting operations, as provided herein, the software application programs may be stored and executed on the proxy server 212, and/or other proxy servers used for performing data formatting operations, and thereby make it unnecessary to have such software applications installed and executed on a relatively large number of clients and/or servers. The proxy server 212 can receive from one or more data-sending servers it is interconnected to, the data requested by one or more clients, such as client 204. Data, in the form of a source page which may include one or more tables, requested by a client, from a server is forwarded to proxy server 212, whereupon the proxy server 212 can, for example, (i) determine whether the table(s) exceeds the visible display width of the VDT of the client to which the formatted data is to be sent, and (ii) if so, reformat the table(s) for display within the visible display width of the VDT 206 based on the disclosed methods. Server 212 can determine whether the table exceeds the visible display width, of for example VDT 206, for the data-requesting client, for example client 204, based on information supplied by such client. After performing the data formatting operations as described herein, the proxy server 212 then provides the formatted table layouts within the reformatted page to the data-requesting client, and the client displays the reformatted page on the display device associated therewith. It will be appreciated that the one or more software application programs may reformat the tables for display on the client's display device regardless of whether or not the source table exceeds the visible display width of the display device.

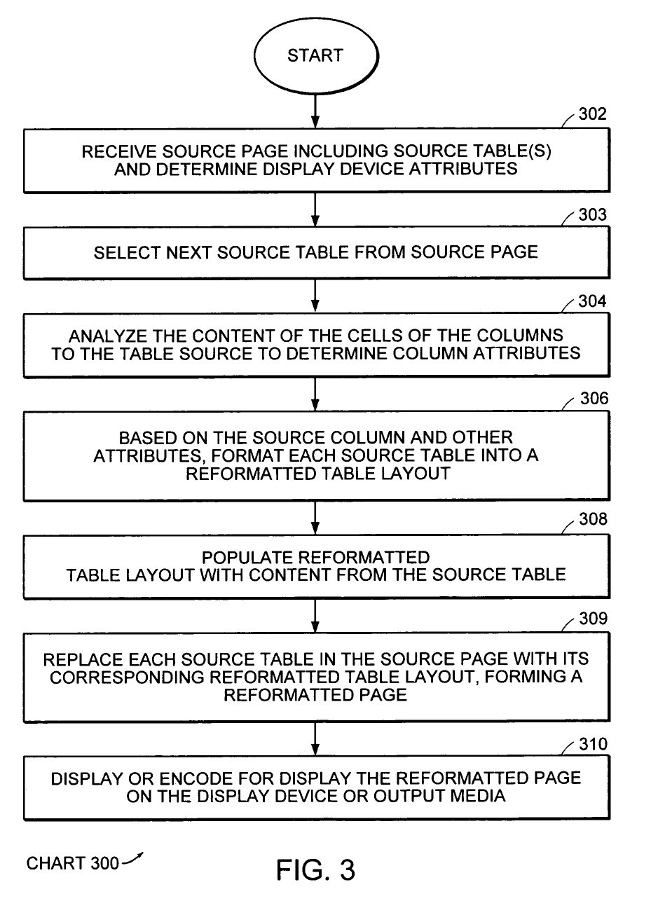

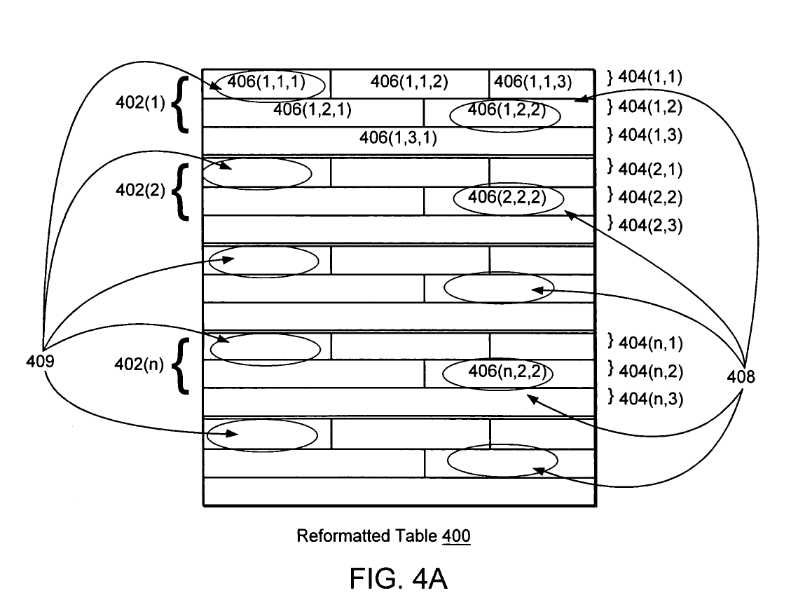

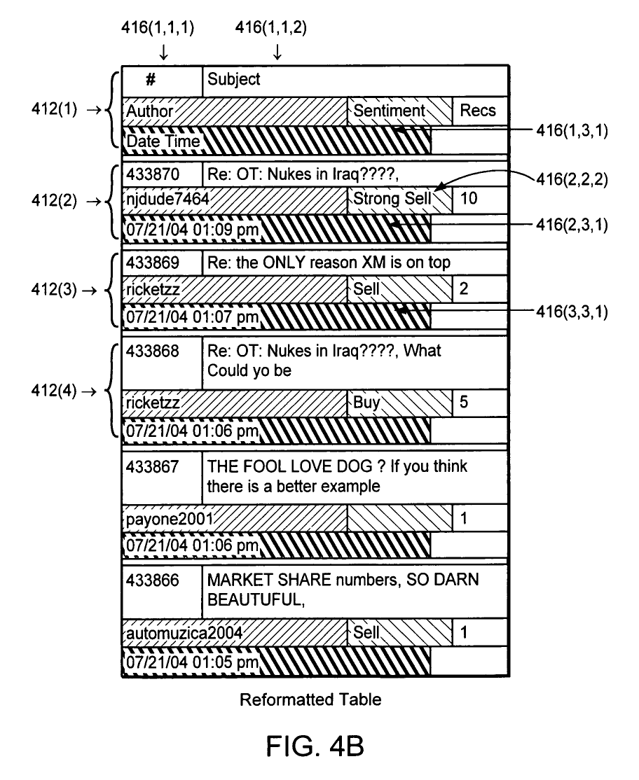

FIG. 3 is a flow chart 300 showing an exemplary method for formatting the table of FIG. 1. FIG. 4A shows an exemplary reformatted table layout formatted by using the FIG. 3 method, while FIG. 4B shows data displayed in accordance with that layout. The invention is not limited to the embodiments shown in FIGS. 3, 4A, and 4B.

In one embodiment, the application program implementing the methods described herein first receives 302 the source page containing one or more source tables, such as source table 100. The source page and source tables 100, or another data structure containing the data that client 204 requested, can be sent by the server 208, or some other data storing device on which the requested data is stored, to the computing device on which the application program for reformatting the source table is executing. As provided herein, the application program may be executing on the server holding the requested data, on the client device, or on a dedicated proxy server, such as the proxy server 212. In addition to the source table 100's data, the computing device executing the table-formatting application program will often additionally receive information specifying the visual and logical attributes of the source table 100. For example, the source table 100 may contain data regarding its logical geometry (e.g., number of rows and columns), visual attributes such as the cell and border shapes and thickness, cell height and width, etc. Additionally, the source table 100 may already be formatted for display on a particular device and/or on a specific application (e.g., a web browser), and as such information regarding source table 100 may be defined using syntax such as Hypertext Markup Language (HTML).

Although the application program may be dedicated to a single display resolution, the illustrated embodiment is intended to encode for display on a variety of devices, so it receives 302 the device attributes of the target device on which the table data is to be displayed. Thus, the client 204 sending a request for the source table data, or for data organized in another type of data structure, can concomitantly send the device attributes of the display device 206, including, for example, the target device's horizontal and vertical display resolutions. Alternately, the client 204 can send a device identifier (e.g. PDA model) or user agent identifier (e.g. browser) which may or may not include specific device attributes, in which case the data formatting application will utilize its own knowledge of the attributes appropriate for the specified target device. The target device attributes may be sent to the device storing the requested data, and, if another device, such as proxy server 212, is executing the data formatting application program, be forwarded with the requested table data to that other device. Alternatively, if client 204 knows which computing device is executing the table formatting application program, the client 204 may forward the target device attributes directly to that device. Where the client 204 performs the data formatting operations, the target device attributes need not be communicated to another remote device, but merely have to be made available to the table formatting application program executing on client 204.

Once the computing device executing the table formatting application program has received the source table and target device attributes, the table formatting application program can begin to generate the reformatted table layout by analyzing 304 the content of the cells in each of the columns of the source table 100. In analyzing the content of the cells of the columns of source table 100, the table formatting application program can determine the respective column attributes for each of the source table columns including, for example, the average content width, the minimum and/or maximum content width, and/or the content width standard deviation. Additionally, the table formatting application program may also determine the Minimum Breakable Content Width (MBCW) for each column, which is the width of the largest single word, or unbreakable character string, contained within any one of the cells of a particular source column. The MBCW thus represents the minimum width necessary to ensure that no word would be truncated when displayed within its respective display column, on the target device 206. As provided herein, these column attributes may subsequently be used by the table formatting application program to generate the reformatted table layout, as shown in FIG. 4A, so that the original source data that was held in source table 100, or display contents based on that data, can be displayed entirely or nearly entirely within the width of the target display device 206, as shown in FIG. 4B, with elimination of the need for horizontal scrolling, while still preserving the visually identifiable row and column interrelationships in the original source table. It will be appreciated that vertical scrolling may have been required for full display of the source table in its original layout, and that, independently, vertical scrolling may be required for full display of the reformatted table layout, and further, that such vertical scrolling will not inhibit visual identification of row and column relationships as would the need for horizontal scrolling which has herein been eliminated. It will further be appreciated that the contents of one or more entire rows of a source table, when reformatted and displayed as described herein, may be visible on the VDT without the need for any horizontal or vertical scrolling, and that such visibility will additionally aid in the visual identification of row and column interrelationships.

It will be appreciated that the table formatting application program will, based on display device attributes, determine whether the source table's dimensions exceed the width of the display device. If they don't, the table formatting application may display the source table on display device 206 without performing table formatting operations on the source table and/or reformatted table layout.

The table formatting application program can thus access the reformatted table layout and, based on one or more of the determined column attributes corresponding to the source columns of source table 100, format 306, the contents of each source row into a sub-row group or other reformatted group. The table formatting application program may then determine, in its respective display, also based on one or more of the source column attributes, the width of each sub-row cell, so that when the reformatted table layout is displayed on the client's display device, all sub-row cells that are associated with a particular column in the source table are vertically aligned, and typically will appear in sub-rows whose ordinal positions in their respective sub-row groups are identical.

More specifically, FIG. 4A shows an example of a reformatted table layout 400 comprising several sub-row groups that are numbered as 402(1), 402(2), and 402(n) (the number in the parenthesis is an index identifying the particular sub-row group in the plurality of sub-row groups). In exemplary reformatted table layout 400, each sub-row group is divided into three sub-rows. A sub-row can be identified by a double index notation where the first number can identify a particular sub-row group, and the second number can identify the particular sub-row within that particular sub-row group. It will be appreciated that, in some embodiments, each reformatted table layout will have the same number of sub-rows in all of its sub-row groups. It will also be appreciated that in other embodiments, within a reformatted table layout, different sub-row groups may be divided into different numbers of sub-rows. It will also be appreciated that in any embodiments each sub-row group may have more or fewer sub-rows than are shown in the exemplary illustrations. As further shown in FIG. 4A, a particular sub-row of a particular sub-row group is divided into one or more display cells which are in turn organized into display columns. Each display cell can be identified using, for example, a threecoordinate index, where the first number can identify the sub-row group, the second number can identify the sub-row, and the third number can identify the set of display cells associated with a source column (this group being sometimes referred to as a display column). For example, display column 406(1,3,1) refers to the first (and only) display column in the third sub-row of the first sub-row group. Other indexing and referencing schemes for accessing and/or formatting a particular sub-row group, sub-row, and/or display column may be used.

In the embodiments of the methods described herein, a display cell located within a particular sub-row of a particular sub-row group can be vertically aligned with its counterpart display cells in the same sub-row location of another sub-row group, forming a display column of sub-row cells in the same reformatted table layout. Thus, display cell 406(1,2,2) can be visually vertically aligned, for example, with display cell 406(2,2,2), and with display cell 406(n,2,2). Together, those display cells form a display column 408, all the cells of which are disposed at the same distance from the left hand margin of the display screen. Further, these visually aligned display cells will typically contain information from cells in the corresponding column of the source table 100. For example, the first non-empty display cells in the sub-row groups' third sub-rows (i.e., display cells 406(1,3,1), 406(2,3,1), 406(3,3,1), and 406(4,3,1)) are vertically aligned and have the same width, forming display column 407. As can also be seen from FIG. 4B, all of this display column's cells contain the same type of information, specifically in this example, the dates and times of messages on an internet message board. That information corresponds to the content of column 120(6) of the reformatted table.

In some embodiments, where source field contents are, for example, ASCII text, a particular font will be known or assigned and the average or particular character width in pixels is used in the following calculations. As noted, the example table-formatting application program also sets 306 the display column width (“DCW”) of the display columns based on the one or more determined column attributes. Thus, for example, display columns corresponding to a particular source column in which the source cells contain, on the average, more alphanumeric characters than other source columns may be set to have a larger width than other display columns that correspond to source columns containing source cells that, on the average, have fewer alphanumeric characters. To illustrate, consider the source table 100 shown in FIG. 4A in which column 120(2), corresponding to the subject description of messages, and column 120(1), corresponding to the message number. Where the DCW of every display column is, for example, set equal to the average width of the source column, then in the embodiments of the table formatting application programs described herein, the width of the second display column, corresponding to the subject description of messages, may be wider than the width of the first display column. Thus, as shown in FIG. 4A, display column 408 may be set to a DCW that is wider than display column 409.

The DCW determined for each display column may be based on other source column attributes such as maximum width, minimum width, minimum breakable content width, etc. The minimum breakable content width may be used, for example, to determine display column width in situations where one or more cells located in a particular source column contain a word that is wider (i.e., has more characters) than the average content width determined for that particular source column, but shorter than the horizontal resolution of the display device. In those situations, basing the display column width on the average content width of the corresponding source column may, for example, result in some words being truncated or otherwise mishandled when displayed within the display column. The table formatting application program described herein may therefore, under such circumstances, set the corresponding display column(s) to a width that would enable exceptionally long words to be properly displayed on the display device. In some embodiments, such lengthy words may alternatively or additionally be broken into multiple parts by the insertion of spaces or other appropriate word delimiters. In some embodiments, cell contents may be modified by substitution of abbreviations or by other methods, where any of these methods may be based on user preferences.

Additionally, in some embodiments of the table formatting methods described herein, the table formatting application program may iteratively reformat sub-row groups to divide the sub-row groups into a different number of sub-rows and/or to alter the number of display columns within a sub-row, and/or to alter the widths of one or more display columns. Iterative reformatting of sub-row groups may facilitate more optimal use of the visible area of the display device. In some embodiments the order of display columns within a sub-row group will be the same as the order of corresponding fields in the source row. In other embodiments the order of display columns will be altered for reasons of display optimization and/or by user specified preferences. Additionally, in some embodiments, if it is determined that the standard deviation of the content width, or other characteristics, of a particular source column such that the content width in a source column varies widely (e.g., some source cells in a particular source column have a width of four characters, while others have a width of fifty characters), then the table formatting application program may, for example, set the display column width to a value that differs from the value that would be otherwise used, to avoid a large quantity of excess vertical or horizontal space that would otherwise occur in some of the sub-rows.

Optionally, in many embodiments the table formatting application program may also produce sub-rows of different heights. Producing sub-rows of differing heights may be preferred, for example, in situations where the entire content of a particular source cell to be displayed is too large to be displayed on a single line within the width that has been determined for that display column. Thus, the table formatting application program may then allow corresponding sub-rows to have sufficient heights so that the content within such display columns in such sub-rows may be set to be displayed on two or more lines within a single display cell of a single sub-row, such technique commonly known as word wrapping. In many embodiments, where such word wrapping occurs for any specific cell of any specific sub-row, other cells displayed in the same specific sub-row would typically have the same height as the word wrapped cell.

Once the table formatting application program has formatted the sub-row groups or reformatted groups comprised of cells forming display columns of herein determined widths, the table formatting application program populates 308 at least some of the display columns in the sub-row groups, or other reformatted groups with the content of the source table. In the case of sub-row groups, for example, contents of the source row cells may be placed in order into the corresponding sub-row cells. For example, with reference to FIG. 1 and FIG. 4B, content in the source row 110(1) of the source table 100 are placed in order into sub-row group 412(1) such that the first cell, namely the cell located in source column 120(1) of source row 110(1) is placed into display cell 416(1,1,1), which is the first display cell of the first sub-row of the first sub-row group. Thereafter, the rest of the cells in source row 110(1), located in columns 120(2) to column 120(6) in the illustrated example, are placed in order into the remainder of the first sub-row group. Subsequently, the next source row, namely source 110(2), may be placed in order into the next sub-row group, namely sub-row group 412(2).

Placement of content from the source table 100 to reformatted table layout 400 may be performed in different orders, and does not require that all content from source table 100 be placed into reformatted table layout 400. For example, the user and/or a data selection application program, may select content from certain source rows and certain source columns, and place only the selected content into the reformatted table layout. For example, in the specific illustration of the content shown in FIGS. 1 and 4B, a user may deem the content in the “Sentiment” column (the fourth column of source table 100) to be unimportant, and accordingly, the table formatting application program (or some other data retrieval application program) may bypass this column when populating the reformatted table layout 400.

Once reformatted table layout 400 has been populated with content from source table 100, and if the table formatting application program is resident on the client 204, then the table formatting application program can display 310 reformatted table layout 400 on, for example, the display device 206 of the client 204. Alternatively, for example, once the reformatted table layout has been populated with content from the source table, and if the table formatting application program is resident on either server 208 or proxy server 212 then the reformatted table layout can be further augmented with HTML, CSS, or other markup language instructions to describe such layout, creating an alternative embodiment of such reformatted table layout. Each source table on a source page is replaced by its corresponding augmented reformatted table layout to form a reformatted page, which is subsequently sent to client 204, where such reformatted page could then be displayed. Such instructions could be created in such manner as would be understood by an existing program (for example, a standards compliant software browser), residing on the client 204. In this latter case, such application program residing on the client, may or may not have any specific knowledge of the methods described herein, but may display such layout correctly by mere compliance with instructions so sent. As can better be seen in FIG. 4B, display of reformatted table layout 400 on the display device 206 can include, for example, formatting the content placed in the display columns of the various sub-row groups so as to make it easier for the users to discern the displayed information. In particular, the corresponding display columns in different sub-row groups may be associated with one or more visual style parameters that could enable the content displayed using such a style parameter(s) to be visually distinguishable from content shown in other display columns of the same sub-row group. In some embodiments, a distinct group of styles will be applied to all cells of a display column associated with each source column. Such application of styles more easily enables a user to perceive that such columns are so related and thus provides visual consistency as would otherwise be available when such source table would be conventionally displayed on a display device of conventional width. Various visual style parameters that may additionally be used to visually distinguish display columns from one another may include, for example, font face, bolding, italicization, underlining, capitalization, non-capitalization, shading, font color, cell background color, cell border color, color of border lines, cell borderline thickness, etc. As can be appreciated, the table formatting application program may use more than one such visual style parameter for a particular display column. Thus, for example, as shown in FIG. 4B, the content in the second display column (i.e., the set of display cells that can be identified as (n,1,2) corresponding to the “Subject” of the messages to be displayed) may be formatted to be displayed in a particular background shade of a particular color that is different from the shade and/or color used for other display columns. In some embodiments a common style will be used for all cells of a sub-row, which would be applied consistently to all corresponding sub-rows throughout the reformatted table. Any application of styles described in any embodiments herein may be based on user preferences.

As can be seen in FIG. 4B, the first sub-row group, namely 412(1), appearing at the top of the display device 206, contains header description information to identify the nature of the content displayed in the following sub-row groups, and hence may be subjected to different display and formatting strategies. Thus, as can be seen, the content of display cell 416(1,3,1) can, for example, be formatted to appear in bold lettering. By contrast, the content in corresponding display cells contained in the same display column, including display cells 416(2,3,1), 416(3,3,1), etc., may be formatted so that bold lettering is not used. Additionally, as will be appreciated, display device 206 can generally display at one time a limited number of sub-row groups, and a user may need to vertically scroll down in order to view those sub-row group that are initially not visible on the display device 206. However, to allow a user to easily identify the nature of the content shown in the displayed sub-row groups, the table formatting application program may reserve a portion of the display device 206 to continuously display the header description information. Thus, as a user scrolls down, the table formatting application program may cause the sub-row group containing the header description (sub-row group 412(1) in FIG. 4B) to remain on the display device.

As may also be seen from FIG. 4B, to facilitate the legibility of the displayed reformatted table layout, the sub-row groups and/or content placed therein may be formatted so as to add empty space before and/or after the displayed content. One way to add empty space between display columns can be by formatting sub-row groups to have more display cells than the number of source columns in the source table. Consequently, some of the generated display cells in the sub-row groups will remain empty, and will appear as empty space when the sub-row groups are displayed. Another way to add empty space to the sub-row groups can be by padding display cells with empty space, thereby creating margins for individual display cells of a given display column. Thus, for example, the first display column of the third sub-row of the sub-row groups (402(n)), of FIG. 4A, which corresponds to the date and time of the messages in FIG. 4B that are to be displayed) can be centered by padding those display cells contained in that display column with empty space in front of, and following the displayed date and time. A third and more typical approach is to use the stylistic attributes of existing or introduced structural elements, e.g. bounding boxes within Cascading Style Sheets, to determine padding, margins, borders and other visual characteristics.

Those of ordinary skill in the art will appreciate that the operation of the table formatting application program can be modified to display the content of source table 100 in a variety of other display configurations and formats. Within any such combination, positional consistency and a reduced need for horizontal scrolling provide improved visual correlation of such data.

The defining elements of any such configuration used to display the elements of a source table on a device or output media too narrow to display one full row of such table are the following:

(1) All cells of each reformatted group are configured to be displayed contiguously in a two dimensional layout entirely or nearly entirely within the width of the display device or output media, such that at least two cells within each reformatted group are configured such that one is entirely above the other, and at least two cells within each reformatted group are configured such that one is entirely to the left of the other.

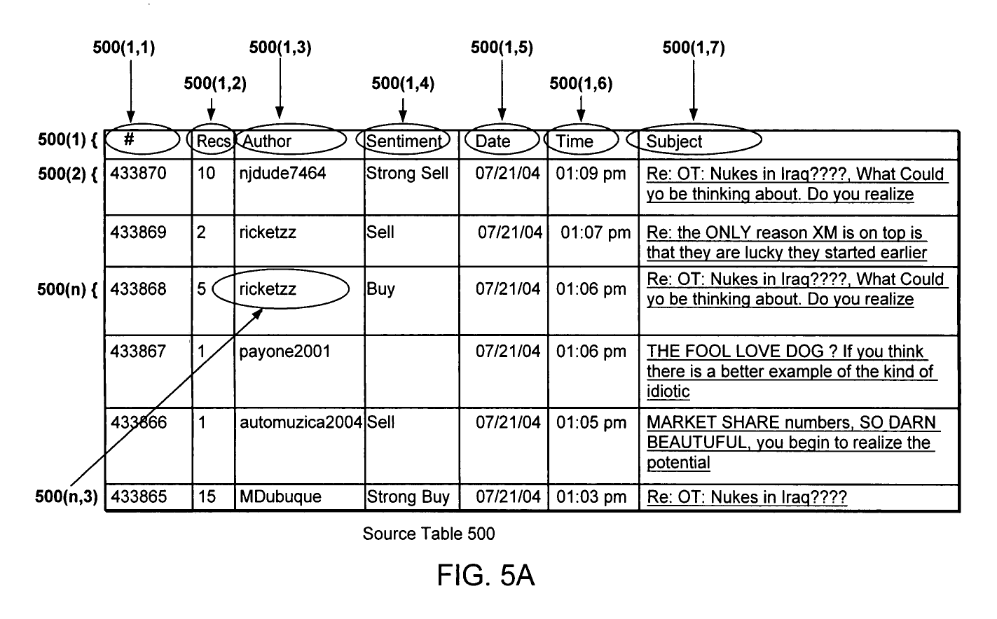

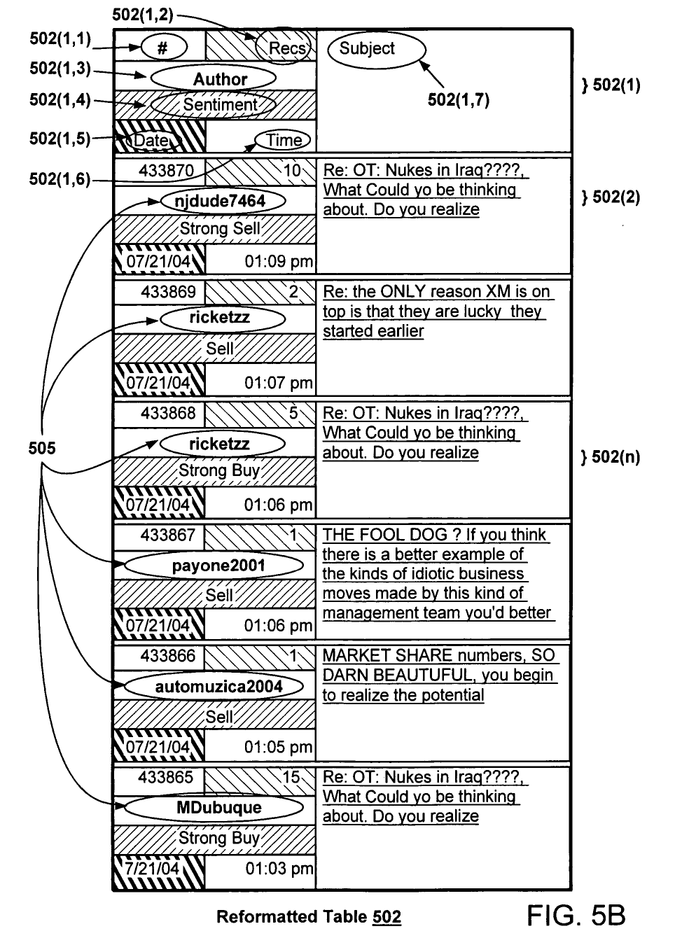

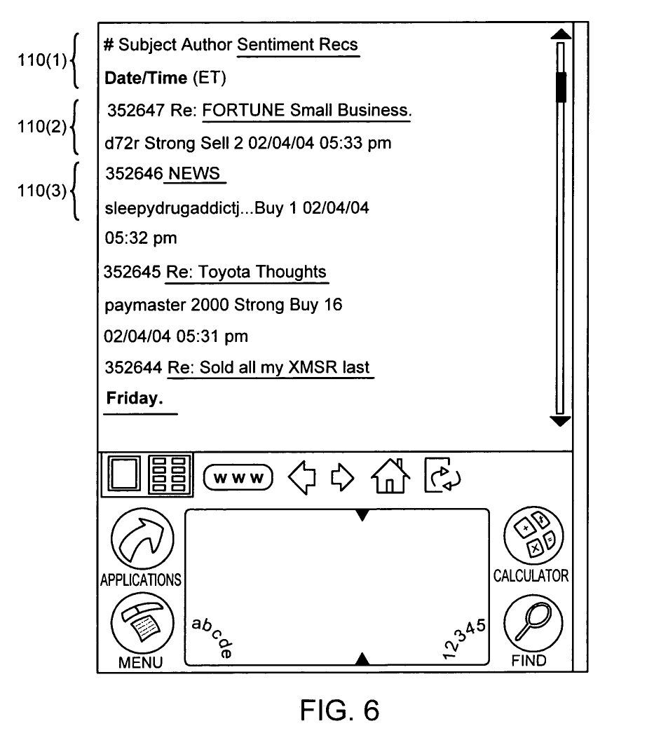

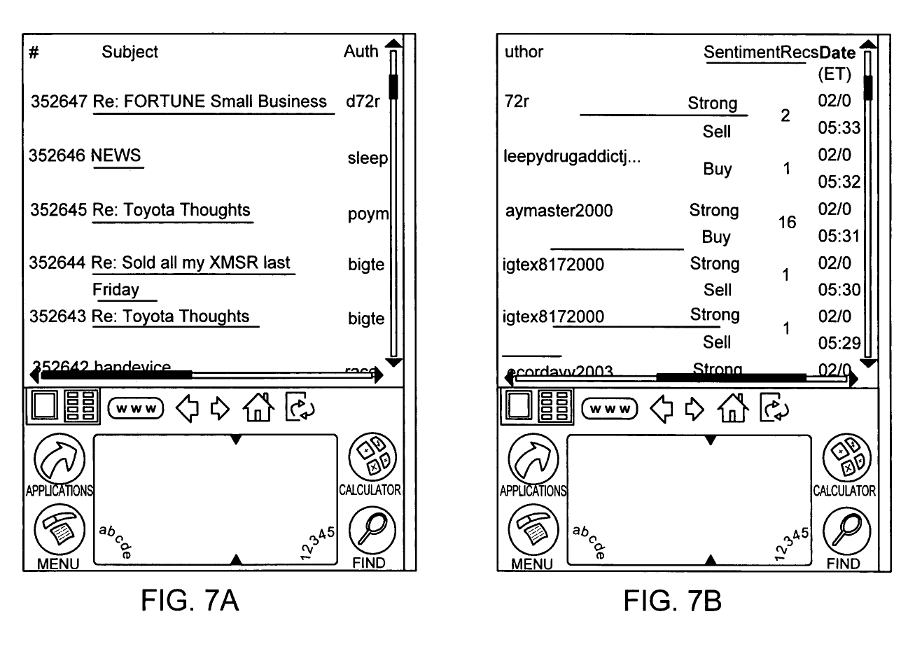

(2) As shown in FIG. 5B, each cell of a reformatted group has both a consistent absolute horizontal position and a consistent relative vertical position that is consistent for all reformatted groups of a given source table, such that the configuration of cells varies only by vertical dimension.

(3) Elimination, or near elimination of the need for horizontal scrolling.

(4) An increase in the number of cells associated with any particular source row that can be seen at any one time as compared to the display of a standard table.

In such configurations, all cells associated with a particular source column would be vertically aligned in the display. The term “consistent relative vertical position” as used herein shall mean that if any two cells associated with one source record are displayed above one another then corresponding cells associated with each other source record will also be displayed above one another, respectively.

It will be appreciated that the data associated with a particular source column may vary significantly in size from one record to the next within a source table. Such variation may be accommodated by varying the height of any cells as needed to display such data. Accordingly, the application program may display word wrapped text or multiple graphics images on multiple lines within a cell. Such variation of cell height shall explain the variation in vertical dimension referred to in the above paragraph (2).

By employing the techniques we describe here, the number of cells associated with a specific source row that are visible at any one time tend to be greater than the number of such cells that would be visible in a standard table layout.

Some of the present invention's embodiments may employ an “embedded-cell” method. Any cell or cells in the display of a sub-row may contain multiple cells, each associated with a respective source column. For example, all cells within the same enclosing cell may be vertically aligned. Additionally, any of those cells so enclosed may instead contain multiple cells distributed horizontally within it, and so on.

In any such reformatted table all of the cells associated with any specific source column form an interrupted or uninterrupted display column.

FIG. 5A shows exemplary source table 500 consisting of rows of cells describing messages on an Internet message board with each related field arranged in typical row-wise fashion.

FIG. 5B shows an exemplary display arrangement in which source table 500 is reformatted and displayed as reformatted table 502. Within FIG. 5B, reference numerals 502(n) refer to respective reformatted groups, and reference numerals 502(n,m) refer to respective cells m in those reformatted groups.

In the exemplary illustration FIG. 5B, the contents of source rows 500(n) of source table 500 are displayed as reformatted groups 502(n) in reformatted table 502. Each reformatted group is configured using the method referred to above as complex method 1. The source cells 500(n,1) through 500(n,7) in source row 500(n) are reformatted, as FIG. 5B's group 502(n), which comprises two cells. The first cell contains reformatted cells 502(n,1) through 502(n,6), and the second cell contains reformatted cell 502(n,7). The first cell contains four vertically aligned cells, the first and last of which each contain two horizontally distributed reformatted cells 502(n,1) with 502(n,2) and 502(n,5) with 502(n,6), respectively. The second and third of the four vertically aligned cells contain reformatted cells 502(n,3) and 502(n,4), respectively.

Each of the reformatted cells 502(n,1) through 502(n,6) is displayed in a distinct interrupted display column, whereas reformatted cell 502(n,7) is displayed in an uninterrupted display column.

Note that in every reformatted group 502(n), cells 502(n,1) and 502(n,2) are above cell 502(n,3), cell 502(n,3) is above cell 502(n,4), and so on: corresponding cells have consistent relative vertical positions within their reformatted groups.

It will also be noted, that in this example, all of the cells of at least one reformatted group would typically be visible at one time when displayed on a typical VDT of limited horizontal resolution, without the need for horizontal scrolling.

Since the display attributes of the display device will generally preclude the simultaneous display of all the sub-row groups and/or reformatted groups comprising the reformatted table layout, a user may display particular parts of the table by scrolling in a vertical or, less frequently, horizontal direction to the sub-row group or reformatted group the user wishes to view.

Additionally, the table formatting application program may associate with corresponding display rows one or more display style parameters to visually distinguish various display rows, and/or display columns, from one another.

Thus, what has been disclosed herein are computer-implemented systems and methods, and computer products for reformatting tabular data based on the known characteristics of a target display device that would otherwise be insufficient in terms of display resolution to retain the visual cues indicating relationships between data items, in a manner that introduces visual and positional consistency for display of such data.

Although the methods, systems, and computer products have been described relative to a specific embodiment thereof, they are not so limited. Obviously many modifications and variations may become apparent in light of the above teachings. Further, the methods described herein may be used to display source data held in something other than a table data structure. For example, the methods and systems described herein may be used to display on a display device, in a manner that enables a user to easily discern and use such displayed data, source data originally organized in a tree data structure whose data fields can be mapped to tabular data.

Those of ordinary skill in the art will recognize or be able to ascertain many equivalents to the exemplary embodiments described herein by using no more than routine experimentation. Such equivalents are intended to be encompassed by the scope of the present disclosure and the appended claims. Accordingly, the appended claims are not to be limited to the embodiments described herein, can include practices other than those described, and are to be interpreted as broadly as allowed under prevailing law.

What is claimed is:

1. For encoding data sets for display, the data in each data set comprising records of which each of at least some includes a plurality of source data fields such that source data fields in different records correspond to one other, a method comprising:
A) dynamically determining from the data set and information related to a display resolution a display layout of cells containing display contents derived from the source data fields, the determination being made in accordance with such a relationship among data sets, display resolutions, and display layouts that:
i) all cells whose contents are derived from source data fields in the same source record are displayed contiguously within the width of the display resolution;
ii) all cells whose contents are derived from the same set of corresponding source data fields have a consistent absolute horizontal position;
iii) all cells whose contents are derived from corresponding source data fields have a consistent relative vertical position, where such consistent relative vertical position shall mean that if any two cells derived from one source record are displayed above one another then respectively corresponding cells derived from any other source record will be respectively displayed above one another; and
iv) there exists at least one pair of combinations of data set and resolution such that each of the two data sets consist of records that consist of fields that are instances of the same set of attributes in the same order and such that:
a) in the display layout that results from a first of those combinations:
(1) at least two cells whose contents are derived from fields of the same record are so configured that one is located entirely above the other; and
(2) at least two cells whose contents are derived from fields of that record are so configured that one is located entirely to the left of the other; and
b) in the display layout that results from the other of the combinations, there are at least two adjacent cells whose contents are derived from the fields from which are derived the contents of non-adjacent fields in the display layout that results from the first combination; and
B) generating signals representing the resultant display layout.

2. A method as defined in claim 1 wherein each such data set, as given before the encoding, additionally specifies a display layout in which, for each of the data set's records, a respective separate row of cells is vertically offset from each other such row and displays the contents of only that record's fields.

3. A method as defined in claim 2 wherein not all fields of any given record are displayed in the same style, and corresponding fields of different records are displayed in the same style.

4. A method as defined in claim 1 wherein not all fields of any given record are displayed in the same style, and corresponding fields of different records are displayed in the same style.

5. A method as defined in claim 1 wherein the display layout is determined by:
A) treating each record as divided into a plurality of sub-records; and
B) so determining cell positions that:
i) cells whose contents are derived from fields in the same subrecord are arranged in the same row; and
ii) cells whose contents are derived from fields in the different subrecords are arranged in different rows.

6. A method as defined in claim 5 wherein each such data set, as given before the encoding, additionally specifies a display layout in which, for each of the data set's records, a respective separate row of cells is vertically offset from each other such row and displays the contents of only that record's fields.

7. A method as defined in claim 6 wherein not all fields of any given record are displayed in the same style, and corresponding fields of different records are displayed in the same style.

8. A method as defined in claim 6 wherein the relationship among data sets, display resolutions, and display layouts is such that there exists at least one combination of data set and display resolution for which in the resultant layout:
A) there is a first cell disposed immediately above a second cell; and
B) at least one of the following is true:
i) the left and right borders of the first cell horizontally bracket the right or left border of the second cell; and
ii) the left and right borders of the second cell horizontally bracket the right or left border of the first cell.

9. A method as defined in claim 5 wherein not all fields of any given record are displayed in the same style, and corresponding fields of different records are displayed in the same style.

10. A method as defined in claim 5 further comprising displaying data in accordance with the display layout that the signals represent.

11. A method as defined in claim 10 wherein the relationship among data sets, display resolutions, and display layouts is such that there exists at least one combination of data set and display resolution for which in the resultant layout:
A) there is a first cell disposed immediately above a second cell; and
B) at least one of the following is true:
i) the left and right borders of the first cell horizontally bracket the right or left border of the second cell; and
ii) the left and right borders of the second cell horizontally bracket the right or left border of the first cell.

12. A method as defined in claim 5 wherein the relationship among data sets, display resolutions, and display layouts is such that there exists at least one combination of data set and display resolution for which in the resultant layout:
A) there is a first cell disposed immediately above a second cell; and
B) at least one of the following is true:
i) the left and right borders of the first cell horizontally bracket the right or left border of the second cell; and
ii) the left and right borders of the second cell horizontally bracket the right or left border of the first cell.

13. A method as defined in claim 1 further comprising responding to the signals representing the display layout by displaying data in the layout thereby represented.

14. For encoding data sets for display, the data in each data set comprising records of which each of at least some includes a plurality of source data fields such that source data fields in different records correspond to one other, an apparatus comprising:
A) circuitry for dynamically determining from the data set and information related to a display resolution a display layout of cells containing display contents derived from the source data fields, the determination being made in accordance with such a relationship among data sets, display resolutions, and display layouts that:
i) all cells whose contents are derived from source data fields in the same source record are displayed contiguously within the width of the display resolution;
ii) all cells whose contents are derived from the same set of corresponding source data fields have a consistent absolute horizontal position;
iii) all cells whose contents are derived from corresponding source data fields have a consistent relative vertical position, where such consistent relative vertical position, shall mean that if any two cells derived from one source record are displayed above one another then respectively corresponding cells derived from any other source record will be respectively displayed above one another; and
iv) there exists at least one pair of combinations of data set and resolution such that each of the two data sets consist of records that consist of fields that are instances of the same set of attributes in the same order and such that:
a) in the display layout that results from a first of those combinations:
(1) at least two cells whose contents are derived from fields of the same record are so configured that one is located entirely above the other; and
(2) at least two cells whose contents are derived from fields of that record are so configured that one is located entirely to the left of the other; and
b) in the display layout that results from the other of the combinations, there are at least two adjacent cells whose contents are derived from the fields from which are derived the contents of non-adjacent fields in the display layout that results from the first combination; and
B) circuitry for generating signals that represent the resultant display layout.

15. An apparatus as defined in claim 14 wherein the display layout is determined by:
A) treating each record as divided into a plurality of sub-records; and
B) so determining cell positions that:
i) cells whose contents are derived from fields in the same subrecord are arranged in the same row; and
ii) cells whose contents are derived from fields in the different subrecords are arranged in different rows.

16. An apparatus as defined in claim 15 wherein each such data set, as given before the encoding, additionally specifies a display layout in which, for each of the data set's records, a respective separate row of cells is vertically offset from each other such row and displays the contents of only that record's fields.

17. An apparatus as defined in claim 16 wherein the apparatus is a proxy mechanism and the data set to be encoded for display is at least a part of information received from a server as a result of a request made by the proxy mechanism in response a client request received thereby.

18. An apparatus as defined in claim 16 wherein the apparatus is a web browser and the data set to be encoded for display is included in a web page received thereby.

19. An apparatus as defined in claim 16 wherein the relationship among data sets, display resolutions, and display layouts is such that there exists at least one combination of data set and display resolution for which in the resultant layout:
A) there is a first cell disposed immediately above a second cell; and
B) at least one of the following is true:
i) the left and right borders of the first cell horizontally bracket the right or left border of the second cell; and
ii) the left and right borders of the second cell horizontally bracket the right or left border of the first cell.

20. An apparatus as defined in claim 15 wherein the relationship among data sets, display resolutions, and display layouts is such that there exists at least one combination of data set and display resolution for which in the resultant layout:
A) there is a first cell disposed immediately above a second cell; and
B) at least one of the following is true:
i) the left and right borders of the first cell horizontally bracket the right or left border of the second cell; and
ii) the left and right borders of the second cell horizontally bracket the right or left border of the first cell.

21. An apparatus as defined in claim 15 wherein the apparatus is a proxy mechanism and the data set to be encoded for display is at least a part of information received from a server as a result of a request made by the proxy mechanism in response a client request received thereby.

22. An apparatus as defined in claim 15 wherein the apparatus is a web browser and the data set to be encoded for display is included in a web page received thereby.

23. An apparatus as defined in claim 14 wherein the apparatus is a proxy mechanism and the data set to be encoded for display is at least a part of information received from a server as a result of a request made by the proxy mechanism in response a client request received thereby.

24. An apparatus as defined in claim 14 wherein the apparatus is a web browser and the data set to be encoded for display is included in a web page received thereby.

25. A storage medium containing instructions readable by a computer system to configure the computer system as the apparatus defined in claim 14.

26. An apparatus as defined in claim 25 wherein the apparatus is a proxy mechanism and the data set to be encoded for display is at least a part of information received from a server as a result of a request made by the proxy mechanism in response a client request received thereby.

27. An apparatus as defined in claim 25 wherein the apparatus is a web browser and the data set to be encoded for display is included in a web page received thereby.

28. A storage medium containing instructions readable by a computer system to configure the computer system as the apparatus defined in claim 15.

29. An apparatus as defined in claim 28 wherein each such data set, as given before the encoding, additionally specifies a display layout in which, for each of the data set's records, a respective separate row of cells is vertically offset from each other such row and displays the contents of only that record's fields.

30. An apparatus as defined in claim 29 wherein the apparatus is a proxy mechanism and the data set to be encoded for display is at least a part of information received from a server as a result of a request made by the proxy mechanism in response a client request received thereby.

31. An apparatus as defined in claim 29 wherein the apparatus is a web browser and the data set to be encoded for display is included in a web page received thereby.

32. An apparatus as defined in claim 28 wherein the apparatus is a proxy mechanism and the data set to be encoded for display is at least a part of information received from a server as a result of a request made by the proxy mechanism in response a client request received thereby.

33. An apparatus as defined in claim 28 wherein the apparatus is a web browser and the data set to be encoded for display is included in a web page received thereby.

34. A storage medium containing instructions readable by a computer system to configure the computer system as the apparatus defined in claim 19.

35. A storage medium containing instructions readable by a computer system to configure the computer system as the apparatus defined in claim 20.
